(19) United States
(12) Patent Application Publication
(10) Pub. No.: US 2025/0316399 A1
(43) Pub. Date: Oct. 9, 2025

(54) MODULAR RADIATION SHIELDING

(71) Applicant: KONINKLIJKE PHILIPS N.V., EINDHOVEN (NL)

(72) Inventors: CHRISTOPH GÜNTHER LEUSSLER, HAMBURG (DE); GEREON VOGTMEIER, AACHEN (DE); STEFFEN WEISS, HAMBURG (DE); BISWAROOP CHAKRABARTI, KOLKATA (IN)

(21) Appl. No.: 18/866,111

(22) PCT Filed: May 11, 2023
(86) PCT No.: PCT/EP2023/062526

§ 371 Date: Nov. 15, 2024

(30) Foreign Application Priority Data
May 17, 2022 (EP) 22173830.5

(51) Int. Cl. G21F 3/04; G21F 1/02

(52) U.S. Cl. CPC G21F 3/04; G21F 1/023

(57) ABSTRACT

The present invention relates to radiation shielding. In order to provide an improved mobile shielding solution, an interconnectable modular radiation-shielding unit (10) is provided for building a radiation-shielding wall. The interconnectable modular radiation-shielding unit comprises a housing and at least one port. The housing at least partially forms a chamber therein that is configmed to hold an X-ray shielding fluid composition. The at least one port leads through the housing into the chamber and being configmed to receive the X-ray shielding fluid composition. The housing comprises a detachably connectable portion that is configmed to be mechanically connected to a detachably connectable portion of a further interconnectable modular radiation-shielding unit to build the radiation shielding wall.

### FIELD OF THE INVENTION

The present invention relates to radiation shielding, and in particular to an interconnectable modular radiation shielding unit, to a radiation shielding wall, to a therapy/diagnostic device comprising the radiation-shielding wall, to a system for building a radiation-shielding wall, and to a method for building a radiation-shielding wall.

### BACKGROUND OF THE INVENTION

Unwanted exposure to ionizing radiation could be biologically hazardous to both humans and the environment, as it can lead to organ damage, cell mutation, component failure, and other harmful effects. X-ray mobile systems and containers are provided with radiation shield. These shields are realized using lead, which is heavy and toxic.

### SUMMARY OF THE INVENTION

It is thus an object of the present invention to provide an improved mobile shielding solution.

The object of the present invention is solved by the subject-matter of the independent claims. Further embodiments and advantages of the invention are incorporated in the dependent claims. Furthermore, it shall be noted that all embodiments of the present invention concerning a method might be carried out with the order of the steps as described, nevertheless this has not to be the only and essential order of the steps of the method as presented herein. The method disclosed herein can be carried out with another order of the disclosed steps without departing from the respective method embodiment, unless explicitly mentioned to the contrary hereinafter.

According to a first aspect of the present invention, there is provided an interconnectable modular radiation-shielding unit for building a radiation-shielding wall. The interconnectable modular radiation-shielding unit comprises a housing and at least one port. The housing at least partially forms a chamber therein that is configured to hold an X-ray shielding fluid composition. The at least one port leads through the housing into the chamber and being configured to receive the X-ray shielding fluid composition. The housing comprises a detachably connectable portion that is configured to be mechanically connected to a detachably connectable portion of a further interconnectable modular radiation-shielding unit to build the radiation shielding wall.

The mobile shielding solution as described herein is a modular radiation shield. The modular radiation shield is designed to be temporarily assembled in any desired location and alignment and then filled with radiation attenuating fluid, which can be configured with respect to the diagnostic/therapy system. In some examples, the interconnectable modular radiation-shielding units may comprise geometric wall elements with hollow structures that can be filled and drained in an easy way with an X-ray absorbing material. The geometric wall elements may take a variety of shapes, and geometric forms including regular or irregular forms and may have a cross-section of substantially any shape including, among others, circular, triangular, square, rectangular, polygonal, regular or irregular shapes, or the like, as well as other symmetrical and asymmetrical shapes, or combinations thereof. At least part of the housing is rigid to provide support for the radiation-shielding wall.

In some examples, the interconnectable modular radiation-shielding units may comprise flexible radiation shield comprising polymer which can be blown up by air.

The X-ray shielding fluid composition may be any appropriate type of fluid that provides X-ray shielding and protection. The type and amount of the X-ray shielding fluid composition to attenuate X-ray radiation is dependent upon the energy of X-rays, the material's composition, and the material's density. In some examples, the X-ray shielding fluid composition may comprise one or more of: high-z noble gas, a suspension of particles in a liquid vehicle, nano-or micro powder in a liquid as homogenous emulsion, nano-or micro powder embedded in a polymer liquid, and water.

According to an embodiment of the present invention, the housing comprises a coating to provide electromagnetic radiation shielding.

The modular radiation shield is also applicable for MR/X-Ray hybrid mobile modular systems. In this case, the modular radiation shield may have an additional coating to prevent electromagnetic radiation to meet a customer need for therapy systems using electromagnetic radiation in combination with X-ray systems. The coating may have one or more conductive fillers to provide a desired resistance and attenuation level.

According to an embodiment of the present invention, the detachably connectable portion is configured to protect against radiation such that when coupled to the detachably connectable portion of the further interconnectable modular radiation-shielding unit, an amount of radiation leaking from the detachably connectable portion is within a desirable range.

This will be explained hereinafter and in particular with respect to the examples shown in FIGS. 2B and 4B.

According to an embodiment of the present invention, there is an overlap between the detachably connectable portion of the interconnectable modular radiation-shielding unit and the detachably connectable portion of the further interconnectable modular radiation-shielding unit.

This will be explained hereinafter and in particular with respect to the examples shown in FIGS. 2B and 4B.

According to an embodiment of the present invention, the housing comprises a plurality of chambers forming a sandwich structure of multiple chamber layers, such that the interconnetable modular radiation-shielding unit has a flexible shielding property depending on an amount of filled chamber layers.

A sandwich structure of several layers may be used to have geometrical structural elements to form the shape e.g. by air channels and then functional elements with X-ray absorbing material. A sandwich of several “chamber layers” for the X-ray absorption fluid composition may allow also for defined shielding properties depending on how many layers are filled. So for low absorption requirements only one layer has to be filled, while for high x-ray absorption performance all of the multiple layers have to be filled.

The aspect of a flexible design and the strength of configuring the shielded room with respect to radiation attenuation by using sandwich structures may have several advantages. For example, the multilayer structure is filled such that it optimally attenuates the radiation of a dedicated X-ray system. It may be advantageous for special situations that the attenuation of the wall structure is not homogeneous, but only optimized for a part of the wall structure, so that less fluid is required and the structure is more lightweight. Also with aspect of weight, the sandwiched structure may also be configured with respect to the radiation pattern of the source.

In some examples, the interconnectable modular radiation-shielding unit further comprises a sensor configured to measure a liquid level inside the chamber. Each interconnectable modular radiation-shielding unit may comprise a sensor disposed inside the chamber to measure the liquid level. The sensor may check whether the chamber of the corresponding interconnectable modular radiation-shielding unit is fully filled.to ensure no radiation leakage.

According to an embodiment of the present invention, the housing comprises an X-ray shielding material.

In order to achieve a good shielding properties for a shielding functionality, the X-ray shielding material may comprise a high-z material (e.g., tantalum).

Examples of the X-ray shielding material may include, but are not limited to, X-ray radio-opaque materials (such as barium sulfate, silcon carbide, silicon nitride, alumina, zirconia, etc), X-ray attenuating materials, X-ray attenuating ceramic materials, X-ray absorbers, and X-ray scattering materials.

For example, the X-ray shielding material may comprise bismuth trioxide particles. Bismuth has gained attention in preclinical research because of its ability to attenuate X-rays and high biocompatibility, which make it an excellent element for use in a biomedical agent or in radiation shielding. It has been shown that lead and bismuth have fairly similar X-ray attenuation per unit density over the majority of the incident photon range. In some examples, the housing 12 may be made of plastic composites, such as PMMA/Bi₂O₃ composites.

The housing may comprise an substantial amount of the X-ray shielding material to achieve a desired shielding effect. For example, if the X-ray shielding material comprises lead, the housing may comprise the lead thickness of 1 to 5 mm for providing the desired shielding effect.

As the housing may provide an additional shielding functionality, the shielding effect of a combination of the housing and the X-ray shielding fluid composition may be increased. In some implementions, this may reduce the amount of X-ray shielding liquid composition that is required to be filled in the chamber to achieve the desired shielding effect.

According to an embodiment of the present invention, the housing is a rigid housing.

This will be explained in detail hereinafter and in particular with respect to the examples shown in FIGS. 2A, 2B, and 3.

According to an embodiment of the present invention, the housing comprises a carbon fiber material, preferably a composite carbon fiber material.

The carbon fiber material is a lightweight material to construct a more lightweight design for mobile vehicles and portable shielding solution.

In some examples, the housing may comprise a composite carbon fiber material. As an example, the composite carbon fiber material may comprise a combination of lead and carbon fiber to obtain stiffness, weight reduction and radiation absorption. The composite carbon fiber material may be part of the individual walls. The composite carbon fiber material may be constructed as modular boards or sheets. These sheets may be jam-packed or connected in or on the individual walls and containers. The composite carbon fiber material, such as composite carbon lead material may provide both the X-ray absorption and the electromagnetic absorption. In this way, no extra layer is required for the electromagnetic absorption.

According to an embodiment of the present invention, the housing is an flexible housing that is inflatable by an air pressure forming an interleaved volume that defines the chamber.

This will be explained in detail hereinafter and in particular with respect to the examples shown in FIGS. 4A and 4B.

According to a second aspect of the present invention, there is provided a radiation-shielding wall. The radiation-shielding wall comprises a plurality of interconnectable modular radiation-shielding units according to the first aspect and any associated example. The plurality of interconnectable modular radiation-shielding units are detachably connected with each other to build the radiation-shielding wall.

This will be explained in detail hereinafter and in particular with respect to the examples shown in FIG. 5.

According to a third aspect of the present invention, there is provided a therapy/diagnostic device comprising the radiation-shielding wall according to the second aspect and any associated example.

A therapy/diagnostic device may have integrated hollow walls, which can be filled with x-ray absorbing liquid such that parts of the imaging volume is radiation shielded. The hollow walls can be planar or have a curved/bended structure.

According to a fourth aspect of the prevent invention, there is provided a system for building a radiation-shielding wall. The system comprises a plurality of interconnectable modular radiation-shielding units according to the first aspect and any associated example, a fluid tank, a fluid pump. The plurality of interconnectable modular radiation-shielding units is usable for building the radiation-shielding wall. The fluid tank is configured to store an X-ray shielding fluid composition. The fluid pump is configured to supply the X-ray shielding fluid composition stored in the fluid tank to the radiation-shielding wall.

This will be explained in detail hereinafter and in particular with respect to the examples shown in FIG. 5.

According to an embodiment of the present invention, the system further comprises a radiation monitoring system comprising one or more sensors configured to monitor a radiation leakage and/or a shielding quality from the radiation-shielding wall.

This will be explained in detail hereinafter and in particular with respect to the examples shown in FIG. 5.

According to an embodiment of the present invention, the system further comprises a controller configured to control the fluid pump to supply the X-ray shielding fluid composition based on the monitored radiation leakage and/or the shielding quality.

This will be explained in detail hereinafter and in particular with respect to the examples shown in FIG. 5.

According to a further aspect of the present invention, there is provided a method for building a radiation-shielding wall. The method comprises the steps of:
providing a plurality of interconnectable modular radiation-shielding units according to the first aspect and any associated example;
connecting the plurality of interconnectable modular radiation-shielding units with each other to build the radiation-shielding wall;
providing a fluid tank that stores an X-ray shielding fluid composition; and
using a fluid pump to supply the X-ray shielding fluid composition to the radiation-shielding wall; and
using the radiation-shielding wall for radiation shielding.
   This will be explained in detail hereinafter and in particular with respect to the examples shown in FIG. 6.

According to an embodiment of the present invention, the method further comprises:
providing radiation information used to indicate an intensity of radiation in an area to be shield;
providing location information used to indicate a location in the area where the radiation-shielding wall is planned to be arranged;
providing a radiation shielding property of the X-ray shielding fluid; and
determining, based on the radiation information, the location information, and the radiation shielding property, a configuration of the radiation-shielding wall.

In some examples, the configuration of the radiation-shielding wall may include a quantity of interconnectable modular radiation-shielding units.

In some examples, the configuration of the radiation-shielding wall may include an amount of the X-ray shielding fluid for building the radiation-shielding wall. For example, the amount of the X-ray shielding fluid may be a total amount of the X-ray shielding fluid for building the radiation-shielding wall. For example, the amount of the X-ray shielding fluid may be an amount of the X-ray shielding wall for each of the interconnectable modular radiation-shielding units.

In some examples, the configuration of the radiation-shielding wall may include an arrangement of the interconnectable modular radiation-shielding units in the radiation-shielding wall.

This will be explained in detail hereinafter and in particular with respect to the examples shown in FIG. 6.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

These and other aspects of the invention will be apparent from and elucidated with reference to the embodiment(s) described hereinafter.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 illustrates an example of a mobile radiation-shielding wall for protecting medical personnel from secondary radiation generated by a diagnostic scanner.

FIG. 2A illustrates a perspective view of an exemplary interconnectable modular radiation-shielding unit for building up the radiation-shielding wall.

FIG. 2B illustrates another view of the exemplary interconnectable modular radiation-shielding unit shown in FIG. 2A.

FIG. 3 illustrates an exemplary radiation-shielding wall.

FIG. 4A illustrates a further example of an interconnectable modular radiation-shielding unit.

FIG. 4B illustrates an exemplary connection approach.

FIG. 5 illustrates a system for building a radiation-shielding wall.

FIG. 6 illustrates a flowchart describing a method for building a radiation-shielding wall.

### DETAILED DESCRIPTION OF EMBODIMENTS

X-ray mobile systems and containers are provided with radiation shield. These shields are realized using lead, which is heavy and toxic.

Towards this end, a mobile shielding solution is proposed in the present disclosure. The proposed mobile shielding solution is a modular radiation shield, which can be configured with respect to the diagnostic/therapy system. The modular radiation shield is designed to be temporarily assembled in any desired location and alignment and then filled with radiation attenuating fluid. The proposed mobile shielding solution has a lightweight radiation shield, and is more flexible. In this way, a more lightweight design for mobile vehicles and portable solutions can be constructed. The radiation shield can be installed or added locally at the hospital. Mobile hospital solutions, which need to configure and protect a diagnostic area from radiation for a certain time interval need a solution for a lightweight easy to install and modular concept. There are also applications where a modular radiation shield can be connected and combined with fixed, mobile and portable x-ray system. In addition to their use in a medical environment, the proposed mobile shielding solution may be used in industrial radiography and non-destructive testing (NDT) applications. Thus, the proposed mobile shielding solution may be used to shield various types of X-ray emitting systems including, but not limited to, a medical system, a cabinet X-ray system, a closed X-ray system, an X-ray inspection system, an X-ray screen system, an X-ray security system, and a baggage X-ray system. The proposed mobile shielding solution may be used to shield various types of sources, such as Cobalt, Iridium, Cesium, Iodine, and Uranium. In some examples, the housing of the interconnectable modular radiation-shielding unit may have a coating to provide electromagnetic radiation shielding. The coating may have one or more conductive filters to provide a desired resistance and attenuation level. Thus, the proposed modular radiation shield may be used for MR/X-Ray hybrid mobile modular systems.

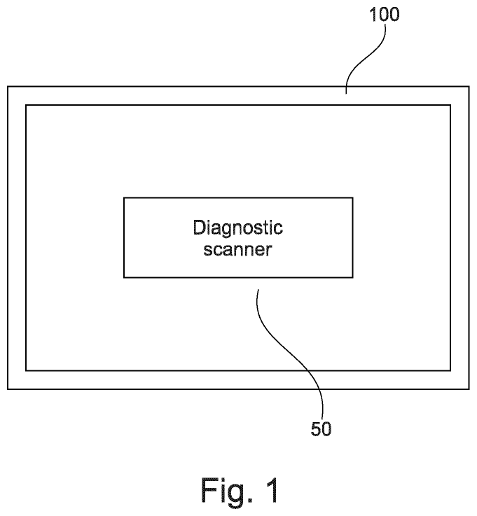

FIG. 1 illustrates an example of a mobile radiation-shielding wall 100 for protecting medical personnel from secondary radiation generated by a diagnostic scanner 50 in e.g., radiology, diagnostic imaging, nuclear medicine, cath labs, OR, or special procedure rooms.

In the example shown in FIG. 1, the diagnostic scanner 50 is completely surrounded by the mobile radiation-shielding wall 100. In some other examples (not shown), the mobile radiation-shielding wall 100 may be used as a radiation-shielding barrier and used for providing radiation shielding in a particular direction. The radiation-shielding wall 100 is built up with a plurality of interconnectable modular radiation-shielding units, which will be explained in detail hereinafter.

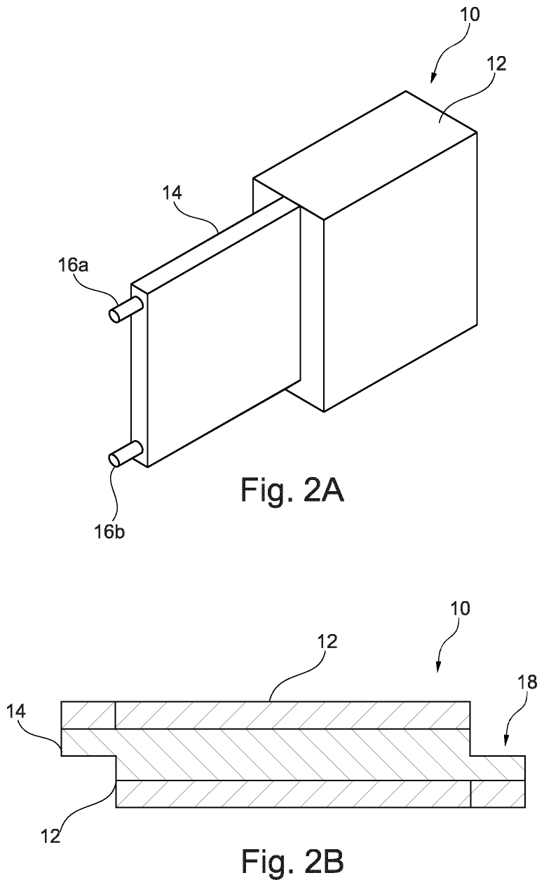

FIG. 2A illustrates a perspective view of an exemplary interconnectable modular radiation-shielding unit 10 for building up the radiation-shielding wall 100.

The interconnectable modular radiation-shielding unit 10 of the illustrated example comprises a housing 12 at least partially forming a chamber 14 therein. At least part of the housing is rigid to provide support for the radiation-shielding wall. In this way, no additional support is required for fixation of the radiation-shielding wall. Depending on the application, the housing 12 may take a variety of shapes, and geometric forms including regular or irregular forms and may have a cross-section of substantially any shape including, among others, circular, triangular, square, rectangular, polygonal, regular or irregular shapes, or the like, as well as other symmetrical and asymmetrical shapes, or combinations thereof. The housing 12 may be planner, curved, or bended. The housing 12 of the interconnectable modular radiation-shielding unit 10 is preferably made of a lightweight material. In some examples, the housing may be made of a carbon fiber material. The carbon fiber material may comprise a composite material to protect against radiation. For example, the carbon fiber material may include bismuth trioxide particles. Bismuth has gained attention in preclinical research because of its ability to attenuate X-rays and high biocompatibility, which make it an excellent element for use in a biomedical agent or in radiation shielding. It has been shown that lead and bismuth have fairly similar X-ray attenuation per unit density over the majority of the incident photon range. In some implementations, the housing may comprise a composite carbon fiber material. As an example, the composite carbon fiber material may comprise a combination of lead and carbon fiber to obtain stiffness, weight reduction and radiation absorption. The composite carbon fiber material may be part of the individual walls. The composite carbon fiber material may be constructed as modular boards or sheets. These sheets may be jam-packed or connected in or on the individual walls and containers. The composite carbon fiber material, such as composite carbon lead material may provide both the X-ray absorption and the electromagnetic absorption. In this way, no extra layer is required for the electromagnetic absorption. In some examples, the housing 12 may be made of plastic composites, such as PMMA/Bi₂O₃ composites.

The housing 12 may comprise an X-ray shielding material. In order to achieve a good shielding properties for a shielding functionality, the X-ray shielding material may comprise a high-z material (e.g., tantalum). Examples of the X-ray shielding material may include, but are not limited to, X-ray radio-opaque materials (such as barium sulfate, silcon carbide, silicon nitride, alumina, zirconia, etc), X-ray attenuating materials, X-ray attenuating ceramic materials, X-ray absorbers, and X-ray scattering materials. For example, the X-ray shielding material may comprise bismuth trioxide particles. Bismuth has gained attention in preclinical research because of its ability to attenuate X-rays and high biocompatibility, which make it an excellent element for use in a biomedical agent or in radiation shielding. It has been shown that lead and bismuth have fairly similar X-ray attenuation per unit density over the majority of the incident photon range. In some examples, the housing 12 may be made of plastic composites, such as PMMA/Bi₂O₃ composites. The housing may comprise an substantial amount of the X-ray shielding material to achieve a desired shielding effect. For example, if the X-ray shielding material comprises lead, the housing may comprise the lead thickness of 1 to 5 mm for providing the desired shielding effect.

The chamber 14 is configured to hold an X-ray shielding fluid composition. For example, the chamber 14 is a hollow structure inside the housing 12 which can be filled and drained with the X-ray shielding fluid composition. At least one port 16 leads through the housing into the chamber 14 and being configured to receive the X-ray shielding fluid composition. In the example of FIG. 1, the at least one port comprises an inlet port 16a and an outlet port 16b. The outlet port 16b is fluidically coupleable to an inlet port 16a of the further interconnectable modular radiation-shielding unit to form a circulation network for the radiation-shielding wall.

The X-ray shielding fluid composition may be any appropriate type of fluid that provides X-ray shielding and protection. The type and amount of the X-ray shielding fluid composition to attenuate X-ray radiation is dependent upon the energy of X-rays, the material's composition, and the material's density.

In some examples, the X-ray shielding fluid may comprise a high-z noble gas, such as Xenon.

In some examples, the X-ray shielding fluid may comprise a suspension of particles in a liquid vehicle. In some examples, the X-ray shielding fluid composition may include nano- or micro powder in a liquid as homogenous emulsion or embedded in a polymer liquid. In some examples, the particles and/or the nano-or micro powder may include one or more X-ray radio-opaque materials, such as barium sulfate, silcon carbide, silicon nitride, alumina, zirconia, etc. In some examples, the particles and/or the nano- or micro powder may include one or more X-ray attenuating materials. In some examples, the particles and/or the nano- or micro powder may include one or more X-ray attenuating ceramic materials. In some examples, the particles and/or the nano- or micro powder may include one or more X-ray absorbers. In some examples, the particles and/or the nano- or micro powder may include one or more X-ray scattering materials. For example, the X-ray shielding fluid composition may be a suspension of polymer bubbles or insoluble salts in a suitable liquid vehicle. A suspension based shielding system may be equipped with a suitable filtration/centrifugation system to separate (and recover) the suspended particles from the suspension after the operation for lightweight storage/transport. Before operation the particles or the powder can be re-suspended in the carrier fluid.

Previous examples are all based on special liquid shielding materials which are relatively expensive, not abundant and chemically reactive. In some implementations, water, instead as shielding material, may be in modular constructions because it is ubiquitous and therefore does not necessarily need to be stored between uses. Other known liquid shielding materials need to be either transported with the mobile system or stored and provided ready to use at the locations where mobile systems will be set up. Water can be released to the environment at a first location and refilled at a new location. In practice this advantage may outweigh the fact that the required layer thickness of shielding with water is by at least one order of magnitude larger than that of lead or bismuth. However, at medium energies used in X-ray therapy (0.5 MeV-5 MeV) the required mass of water is comparable to that of lead shielding and water layers are about 10-20 fold thicker than lead so that water shielding is especially suited to these such medical applications. Water is compatible with standard pumps and pipes. It is liquid enough to be easily pumped between containers. Water may be stored and reused if not available in large amounts. It may be used for other purposes after radiation shielding, e.g. in the hospital, in agriculture or in industry.

The housing 12 further comprises a detachably connectable portion 18 that is configured to be mechanically connected to a detachably connectable portion of a further interconnectable modular radiation-shielding unit to build the radiating shielding wall 100. The detachably connectable portion 18 is configured to protect against radiation such that when coupled to the detachably connectable portion of the further interconnectable modular radiation-shielding unit, an amount of radiation leaking from the detachably connectable portion is within a desirable range. For example, as shown in FIG. 2B, there is an overlap between the detachably connectable portion of the interconnectable modular radiation-shielding unit and the detachably connectable portion of the further interconnectable modular radiation-shielding unit.

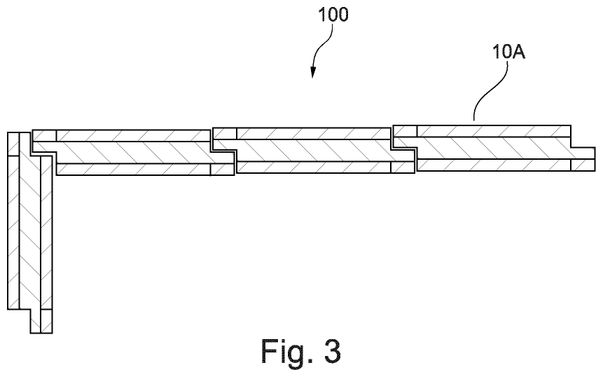

FIG. 3 illustrates a further example of a mobile radiation-shielding wall 100 formed by some interconnectable modular radiation-shielding unit 10 as shown in FIG. 2A. In this example, each interconnectable modular radiation-shielding unit 10 has an overlapping chamber structures. When two inerconnectable modular radiation-shielding units 10 are connected, the overlapping chamber structures enable continuous shielding performance and no (or only a limited amount) radiation leak. Although FIG. 3 shows that the detachably connectable portion 18 comprises an overlapping chamber structures as an example, it will be appreciated that in some implementations the detachably connection portion 18 may not comprise any chamber structure, but only comprise a housing material, such as carbon fiber material with a composite material, to protect against radiation.

FIGS. 2A and 2B show an exemplary interconnectable modular radiation-shielding unit with a single layer. In some examples (not shown), the housing 12 comprises a plurality of chambers forming a sandwich structure of multiple chamber layers. A sandwich structure of several layers may be used to have geometrical structural elements to form the shape e.g. by air channels and then functional elements with X-ray absorbing material. A sandwich of several “chamber layers” for the X-ray absorption fluid composition may allow also for defined shielding properties depending on how many layers are filled. So for low absorption requirements only one layer has to be filled, while for high x-ray absorption performance all of the multiple layers have to be filled. Thus, the sandwich could be also a sandwich of several chambers in parallel that could be filled in dependence of a desired shielding quality. For example, the shielding quality may be monitored by a sensor, which may be used to control the selection of an amount of chamber layers to be filled to achieve the desired shielding quality.

The aspect of a flexible design and the strength of configuring the shielded room with respect to radiation attenuation by using sandwich structures may have several advantages. For example, the multilayer structure is filled such that it optimally attenuates the radiation of a dedicated X-ray system. It may be advantageous for special situations that the attenuation of the wall structure is not homogeneous, but only optimized for a part of the wall structure, so that less fluid is required and the structure is more lightweight. Also with aspect of weight, the sandwiched structure may also be configured with respect to the radiation pattern of the source.

It will be appreciated that the above-described interconnectable modular radiation-shielding unit 10 may also be used to build up a therapy/diagnostic device. For example, a therapy/diagnostic device may have integrated hollow walls, which can be filled with x-ray absorbing liquid such that parts of the imaging volume is radiation shielded. The hollow walls can be planar or have a curve or bended structure.

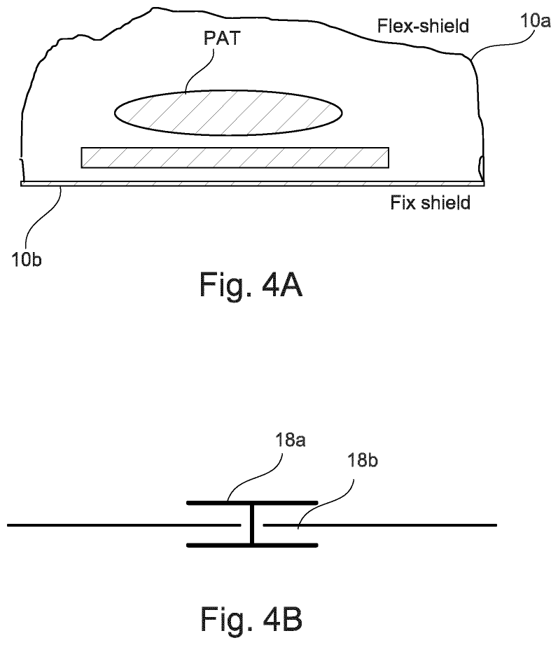

FIG. 4A illustrates a further example of an interconnectable modular radiation-shielding unit 10a. In this example, the housing of the illustrated interconnectable modular radiation-shielding unit 10a is a flexible housing that is inflatable by an air pressure forming an interleaved volume that defines the chamber (not shown). The flexible interconnectable modular radiation-shielding unit 10a is also referred to as flex-shield. The flexible housing may comprise any suitable flexible material, such as polymer. The chamber can be filled with an X-ray shielding fluid composition, such as any X-ray shielding fluid composition described with respect to the example shown in FIGS. 2A and 2B.

In the example shown in FIG. 4A, the interconnectable modular radiation-shielding unit 10a may be in the form of a modular flexible tent. A patient PAT or an X-ray device (not shown) may be located inside the modular flexible tent. The modular flexible tent may be inflated by air pressure and contains interleaved volumes, which can be filled with X-ray radiation-shielding fluid.

The flexible tent 10a may be connected to a support structure, such as a rigid modular radiation-shielding plate 10b shown in FIG. 4A. The modular radiation-shielding plate 10b may also be referred to as fix shield. The modular radiation-shielding plate 10b may be made of any suitable radiation-shielding material, such as carbon fiber material with a composite material, plastic composites, polymer, and the like. The flexible modular radiation-shielding unit 10a and the rigid modular radiation-shielding plate 10b may be connected in such a way that no radiation can leave. For examples, as shown in FIG. 4B, the detachably connectable portion 18a of the flexible interconnectable modular radiation-shielding unit 10a and the detachably connectable portion 18b of the rigid modular radiation shielding plate 10b are interleaved to protect against radiation leakage.

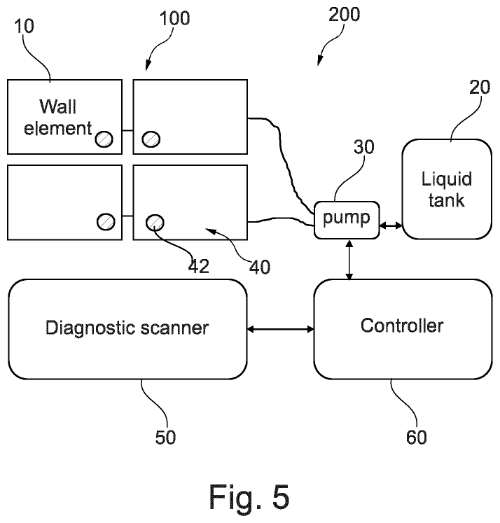

FIG. 5 illustrates an example of a system 200 for building a radiation-shielding wall 100 to shield radiation generated by a diagnostic scanner 50. The system 200 comprises a plurality of interconnectable modular radiation-shielding units 10 usable for building the radiation-shielding wall, a fluid tank 20, a fluid pump 30, a radiation monitoring system 40, and a controller 50.

The interconnectable modular radiation-shielding units 10 may be connected with each other to form the radiation-shielding wall 100. Depending on the application of the radiation-shielding wall, the interconnectable modular radiation-shielding units 10 may comprise one or more rigid interconnectable modular radiation-shielding units shown in FIGS. 2A, 2B, and 3 and/or one or more flexible interconnectable modular radiation-shielding units shown in FIGS. 4A and 4B. Although FIG. 5 may show a limited number of interconnectable modular radiation-shielding units by way of example, it will be appreciated that in some implementations a greater or less number of interconnectable modular radiation-shielding units may be used.

The fluid tank 20 stores an X-ray shielding fluid composition. The fluid tank 20 may comprise one or more reservoirs configured to store and supply the X-ray shielding fluid composition to or from the fluid tank 20. In some examples, the fluid tank 20 may store two or more different X-ray shielding fluid compositions.

The fluid pump 30 is in fluid communication with the fluid tank 20 and the radiation-shielding wall 100 and is configured to supply the X-ray shielding fluid composition stored in the fluid tank to the radiation-shielding wall. Examples of the fluid pump 30 may include, but are not limited to, mechanical pumps, magnetic pumps, centrifugal pumps, diaphragm pumps, gear pumps, flexible impeller pumps, peristaltic pumps, piston pumps, and rotary valve pumps.

The radiation monitoring system 40 comprises one or more sensors 42 configured to monitor a radiation leakage from the radiation-shielding wall. The quality of the radiation shield may be continuously monitored by the radiation monitoring system 40. For example, as shown in FIG. 5, the radiation monitoring system 40 comprises four sensors 42. Each sensor 42 may be disposed on a respective interconnectable modular radiation-shielding unit 10. In some examples, the sensors 42 may comprise one or more sensors configured to acquire at least a portion of penetrating X-ray radiation stimulus generated by the diagnostic scanner 50 and transduce the penetrating X-ray radiation stimulus into at least one measurand indicative of a radiation leakage. As previously mentioned, the X-ray shielding fluid composition may be a suspension of particles or nano-or micro powder (e.g., polymer bubbles or insoluble salts) in a suitable liquid vehicle. In cases where the suspended particles tend to settle, adequate suspension density at all levels within the scaffolding need to be ensured. In this case, two or more sensors 42 may be disposed on a single interconnectable modular radiation-shielding unit 10 to monitor shielding quality at different locations. Based on this information, equal suspension density may be maintained by the fluid pump 30. Examples of the sensors may include, but are not limited to, scintillators, dosimeters, optical stimulated luminescence detectors, photodiode arrays, charge-coupled devices (CCD), and complementary meta-oxide-semiconductor (CMOS) devices. In some examples, the sensors 42 may comprise one or more sensors measuring the mechanical and electromagnetic quality of the shielding. In some examples, the sensors 42 may comprise one or more sensors for detecting the presence of human subjects in the environment. The acquired sensor data may be fed to a trained neuronal network, which may be part of the controller. The output of the trained network controls the devices to maintain the security and quality of the shielding. In some examples, the sensor data may be further communicated to a remote command center for real time monitoring and control.

The fluid pump 30, the radiation monitoring system 40, and the diagnostic scanner 50 are communicatively connected to the controller 60. The communication may be wired or wireless. The controller 60 may comprise various physical and/or logical components for communicating and manipulating information, which may be implemented as hardware components (e.g. computing devices, processors, logic devices), executable computer program instructions (e.g. firmware, software) to be executed by various hardware components, or any combination thereof, as desired for a given set of design parameters or performance constraints. In some implementations, the controller 60 may be embodied as, or in, a device or apparatus, such as a server, workstation, or mobile device. The controller 60 may comprise one or more microprocessors or computer processors, which execute appropriate software. The software may have been downloaded and/or stored in a corresponding memory, e.g. a volatile memory such as RAM or a non-volatile memory such as flash. The software may comprise instructions configuring the one or more processors to perform the functions described herein. It is noted that the controller 60 may be implemented with or without employing a processor, and also may be implemented as a combination of dedicated hardware to perform some functions and a processor (e.g. one or more programmed microprocessors and associated circuitry) to perform other functions. For example, the functional units of the controller 60 may be implemented in the device or apparatus in the form of programmable logic, e.g. as a Field-Programmable Gate Array (FPGA). In general, each functional unit of the apparatus may be implemented in the form of a circuit.

The controller 50 is operable to manage fluid flow of the X-ray shielding fluid composition to or from the fluid tank 20 and along one or more of the chambers of the interconnectable modular radiation-shielding unit 10. In some examples, during operation, the radiation monitoring system 40 may monitor a radiation leakage from the radiation-shielding wall 100 to check whether the radiation-shielding wall 100 is activated or functional to provide radiation shielding. In response to detecting an actual or a potential exposure event, the controller 60 may activate the flow of the X-ray shielding fluid composition from the fluid tank 20 and to the chambers of the interconnectable modular radiation-shielding units 10. In other words, the radiation monitor may directly control the fluid pump to prevent radiation leakage.

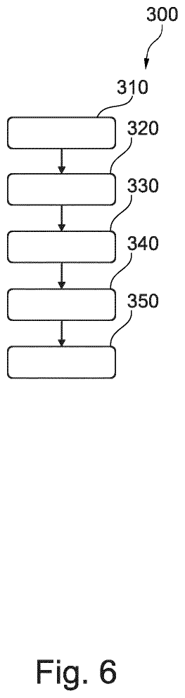

FIG. 6 illustrates a flowchart describing a method 300 for building a radiation-shielding wall.

At block 310, a plurality of interconnectable modular radiation-shielding units is provided. The plurality interconnectable modular radiation-shielding units may comprise one or more rigid interconnectable modular radiation-shielding units, such as units shown in FIGS. 2A, 2B, and 3, and/or one or more flexible interconnectable modular radiation-shielding units, such as units shown in FIG. 4A and 4B.

At block 320, the plurality of interconnectable modular radiation-shielding units are connected with each other to build the radiation-shielding wall. An exemplary radiation-shielding wall is shown in FIG. 5. A mechanical locking mechanism may be provided to provide assistance to the coupling and uncoupling of the interconnectable modular radiation-shielding units. For example, the individual wall elements may be clicked together into a frame.

At block 330, a fluid tank is provided that stores an X-ray shielding fluid composition.

At block 340, a fluid pump is used to supply the X-ray shielding fluid composition to the radiation-shielding wall. A mobile vehicle can be equipped and loaded with these elements, tank and pump. Liquid shielding can easily be replaced, recovered and transported.

At bock 350, the radiation-shielding wall is used for radiation shielding.

In some implementations, it may be desired to determine a quantity of interconnectable modular radiation-shielding units and an amount of the radiation shielding fluid for building the radiation-shielding wall, e.g., following any change in the radiation-producing equipment or following any change in e.g., the number, location, and/or arrangement of the radiation-shielding units in the radiation-shielding wall. In an example, if the diagnostic scanner 50 shown in FIG. 1 is changed to a different diagnostic scanner e.g., with a higher radiation intensity, the radiation-shielding wall 100 may have to be reconfigured to provide a desired shielding effect. In another example, if the radiation-shielding wall 100 shown in FIG. 1 may be repositioned e.g., in a closer distance to the diagnostic scanner 50, the radiation-shielding wall 100 may also have to be reconfigured to provide a desired shielding effect. The quantity of interconnectable modular radiation-shielding units and/or the amount of the radiation shielding fluid for building the radiation-shielding wall may be determined as follows:

First, radiation information used to indicate an intensity of radiation in an area to be shield is provided. The radiation information may also comprise a radiation pattern. In some examples, the radiation information may be determined based on the technical data of the radiation-producing equipment, such as the diagnostic scanner (e.g., CT scanner) shown in FIG. 1. In some examples, the radiation information may be determined based on previous measurements of the intensity of radiation.

Second, location information is provided which is used to indicate a location in the area where the radiation-shielding wall will be arranged. In some examples, the location information may comprise a relative distance of the radiation-shielding wall to the radiation-producing equipment. The relative distance may be a three-dimensional distance between the radiation-producing equipment (e.g., CT scanner) and the radiation-shielding wall.

Third, a radiation shielding property of the radiation shielding fluid composition is provided. For example, the radiation shielding property may comprise the attenuation coefficient and the material density which can be used to estimate the transmission of e.g., X-ray radiation through the X-ray shielding liquid.

Fourth, based on the radiation information, the location information, and the radiation shielding property, a configuration of the radiation-shielding wall is determined to achieve a desired radiation attenuation.

In some examples, the configuration of the radiation-shielding wall may include a quantity of interconnectable modular radiation-shielding units.

In some examples, the configuration of the radiation-shielding wall may include an amount of the X-ray shielding fluid for building the radiation-shielding wall. For example, the amount of the X-ray shielding fluid may be a total amount of the X-ray shielding fluid for building the radiation-shielding wall. For example, the amount of the X-ray shielding fluid may be an amount of the X-ray shielding wall for each of the interconnectable modular radiation-shielding units.

In some examples, the configuration of the radiation-shielding wall may include an arrangement of the interconnectable modular radiation-shielding units in the radiation-shielding wall.

The above-described method for determining the quantity of interconnectable modular radiation-shielding units and/or the amount of the radiation shielding fluid for building the radiation-shielding wall may be carried out by computer program instructions running on means which, in the context of the present disclosure, provide data processing functions. Such means can, for example, be embedded in a personal computer, smartphone, etc. The calculated results, i.e., the quantity of interconnectable modular radiation-shielding units and/or the amount of the radiation shielding fluid may be conveyed to a user e.g., via a graphical user interface (e.g., a display) to provide a guidance for building the radiation-shielding wall.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

In another exemplary embodiment of the present invention, a computer program or a computer program element is provided that is characterized by being adapted to execute the method steps of the method according to one of the preceding embodiments, on an appropriate system.

The computer program element might therefore be stored on a computer unit, which might also be part of an embodiment of the present invention. This computing unit may be adapted to perform or induce a performing of the steps of the method described above. Moreover, it may be adapted to operate the components of the above described apparatus. The computing unit can be adapted to operate automatically and/or to execute the orders of a user. A computer program may be loaded into a working memory of a data processor. The data processor may thus be equipped to carry out the method of the invention.

This exemplary embodiment of the invention covers both, a computer program that right from the beginning uses the invention and a computer program that by means of an up-date turns an existing program into a program that uses the invention.

Further on, the computer program element might be able to provide all necessary steps to fulfil the procedure of an exemplary embodiment of the method as described above.

According to a further exemplary embodiment of the present invention, a computer readable medium, such as a CD-ROM, is presented wherein the computer readable medium has a computer program element stored on it which computer program element is described by the preceding section.

A computer program may be stored and/or distributed on a suitable medium, such as an optical storage medium or a solid state medium supplied together with or as part of other hardware, but may also be distributed in other forms, such as via the internet or other wired or wireless telecommunication systems.

However, the computer program may also be presented over a network like the World Wide Web and can be downloaded into the working memory of a data processor from such a network. According to a further exemplary embodiment of the present invention, a medium for making a computer program element available for downloading is provided, which computer program element is arranged to perform a method according to one of the previously described embodiments of the invention.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

1. An interconnectable modular radiation-shielding unit for building a radiation-shielding wall, comprising:
a housing at least partially forming a chamber therein that is configured to hold an X-ray shielding fluid composition; and
at least one port leading through the housing into the chamber and being configured to receive the X-ray shielding fluid composition;
wherein the housing comprises a detachably connectable portion that is configured to be mechanically connected to a detachably connectable portion of a further interconnectable modular radiation-shielding unit to build the radiation shielding wall.

2. The interconnectable modular radiation-shielding unit according to claim 1, wherein the housing comprises a coating to provide electromagnetic radiation shielding.

3. The interconnectable modular radiation-shielding unit according to claim 1, wherein the detachably connectable portion is configured to protect against radiation such that when coupled to the detachably connectable portion of the further interconnectable modular radiation-shielding unit, an amount of radiation leaking from the detachably connectable portion is within a desirable range.

4. The interconnectable modular radiation-shielding unit according to claim 3, wherein there is an overlap between the detachably connectable portion of the interconnectable modular radiation-shielding unit and the detachably connectable portion of the further interconnectable modular radiation-shielding unit.

5. The interconnectable modular radiation-shielding unit according to claim 1, wherein the housing comprises a plurality of chambers forming a sandwich structure of multiple chamber layers, such that the interconnectable modular radiation-shielding unit has a flexible shielding property depending on an amount of filled chamber layers.

6. The interconnectable modular radiation-shielding unit according to claim 1, wherein the housing comprises an X-ray shielding material.

7. The interconnectable modular radiation-shielding unit according to claim 1, wherein the housing comprises a rigid housing.

8. The interconnectable modular radiation-shielding unit according to claim 1, wherein the housing comprises an flexible housing that is inflatable by an air pressure forming an interleaved volume that defines the chamber.

9. (canceled)

10. (canceled)

11. A system for building a radiation-shielding wall, comprising:
a plurality of interconnectable modular radiation-shielding units, wherein each interconnectable modular radiation-shielding unit comprises:
a housing at least partially forming a chamber therein that is configured to hold an X-ray shielding fluid composition; and
at least one port leading through the housing into the chamber and being configured to receive the X-ray shielding fluid composition, wherein the housing comprises a detachably connectable portion that is configured to be mechanically connected to a detachably connectable portion of a further interconnectable modular radiation-shielding unit to build the radiation shielding wall;
a fluid tank configured to store an X-ray shielding fluid composition; and
a fluid pump configured to supply the X-ray shielding fluid composition stored in the fluid tank to the radiation-shielding wall.

12. The system according to claim 11, further comprising:
a radiation monitor comprising one or more sensors configured to monitor a radiation leakage and/or a shielding quality from the radiation-shielding wall.

13. The system according to claim 11, further comprising:
a controller configured to control the fluid pump to supply the X-ray shielding fluid composition based on the monitored radiation leakage and/or the monitored shielding quality.

14. A method for building a radiation-shielding wall, comprising:
providing a plurality of interconnectable modular radiation-shielding units, wherein each interconnectable modular radiation-shielding unit comprises:
a housing at least partially forming a chamber therein that is configured to hold an X-ray shielding fluid composition; and
at least one port leading through the housing into the chamber and being configured to receive the X-ray shielding fluid composition, wherein the housing comprises a detachably connectable portion that is configured to be mechanically connected to a detachably connectable portion of a further interconnectable modular radiation-shielding unit to build the radiation shielding wall;
connecting the plurality of interconnectable modular radiation-shielding units with each other;
providing a fluid tank that stores an X-ray shielding fluid composition;
using a fluid pump to supply the X-ray shielding fluid composition to the radiation-shielding wall; and
using the radiation-shielding wall for radiation shielding.

15. The method according to claim 14, further comprising:
providing radiation information for indicating an intensity of radiation in an area to be shield;
providing location information for indicating a location in the area where the radiation-shielding wall is to be arranged;
providing a radiation shielding property of the X-ray shielding fluid composition; and
determining, based on the radiation information, the location information, and the radiation shielding property, a configuration of the radiation-shielding wall.
